(19) United States
(12) Patent Application Publication
(10) Pub. No.: US 2021/0324191 A1
(43) Pub. Date: Oct. 21, 2021

(54) USE OF A SELF-HEALING POLY(ALKYLENE CARBONATE)

(71) Applicant: REPSOL, S.A., Madrid (ES)

(72) Inventors: Sonia SEGURA FERNÁNDEZ, Madrid (ES); Laura MARÍN PERALES, Madrid (ES); Manuel LÓPEZ REYES, Madrid (ES); Mónica GARCÍA RUIZ, Madrid (ES); Carolina RUIZ ORTA, Madrid (ES); José Miguel MARTÍN MARTÍNEZ, Alicante (ES); Andrés Jesús YÁÑEZ PACIOS, Alicante (ES); Sara SANCHO QUEROL, Alicante (ES)

(21) Appl. No.: 16/467,808

(22) PCT Filed: Feb. 7, 2018
(86) PCT No.: PCT/EP2018/053093

§ 371 Date: Jun. 7, 2019

(30) Foreign Application Priority Data
Feb. 7, 2017 (EP) 17382052.3

(51) Int. Cl. C08L 69/00; B29C 73/18; C08G 64/34; C08K 5/12; C08K 5/521; C08K 5/11; C08K 5/101

(52) U.S. Cl. CPC C08L 69/00; B29C 73/18; C08G 64/34; C08K 5/101; C08K 5/521; C08K 5/11; C08K 5/12

(57) ABSTRACT

A mixture having a poly(alkylene carbonate) and a non-polymeric organic molecule having a molecular weight below 1,000 Da may be used as a self-healing material. The non-polymeric organic molecules having a molecular weight below 1,000 Da may also be used to impart self-healing behaviour to a mixture having a poly(alkylene carbonate).

### TECHNICAL FIELD

The disclosure relates to self-healing polymer mixtures.

### BACKGROUND

Damage to polymers can be caused at various points in the life cycle from manufacture of different products, installation and operation. Relatively minor defects in polymeric products, such as scratches, small cuts and puncture damage can compromise their physical integrity and lead to failures.

In order to reduce failure rates, a growing interest exists in the design of self-healing materials in the field of polymer chemistry which have a variety of industrial applications. Self-healing materials may have applications in tubes, protection surfaces in general, tyres, all kinds of leak-tight structures (e.g. fuel tanks), packaging, films, different types of vessels, insulation, coatings, sealants and layers (e.g. electrical cables, optical fibre cables), all within a wide range of industries, including, automotive, marine, construction and/or aerospace and energy industries. Effective self-healing materials would increase the life of products and significantly reduce related maintenance expenditure for asset owners and operators.

Industrialization of poly(alkylene carbonate) has progressed as a polymer using carbon dioxide as a raw material. The poly(alkylene carbonate) is a thermoplastic with an excellent processability. It is easy to adjust its degradation profile to produce an eco-friendly biodegradable polymer. In addition, the poly(alkylene carbonate) has been applied to various uses as an eco-friendly resin due to excellent strength and transparency, barrier properties, and clean burning characteristics.

Documents US 2014/037964 A1, EP 3 103 846 A1 and JP 2016/108347 A teach the self-healing properties of polymerized polymers, namely, polyurethanes. EP 3 103 846 A1 teaches the self-healing properties of a polymerized polyurethane resulting from the polymerization of a PPC and a polyisocyanate. US 2014/037964 A1 also studies the self-healing properties of a polyurethane derived from the polymerization of a mixture comprising at least one polycarbonate polyol, at least one polyisocyanate, at least one solvent and at least one surfactant. Similar studies can be found in JP 2016/108347 A.

WO 2017/021448 discloses a self-healing mixture comprising as essential components a) a polyalkylene compound; and b) a polyether carbonate polyol. Tackifying agents are also disclosed as optional components.

However, there is still a need to provide a poly(alkylene carbonate) that can display self-healing behaviour.

### SUMMARY

In order to solve the above mentioned problems, the present disclosure provides a self-healing poly(alkylene carbonate) mixture comprising low molecular weight organic molecules. The poly(alkylene carbonate) mixtures of the present disclosure are capable of totally or partially recovering their physical properties after damage, even after very short periods of time. For example, a significant recovery in tensile strength is observed at room temperature only 5 seconds after the cut. There is no need to force conditions, and the self-healing behaviour can be realized even without external stimulus, for example at room temperature without substantive additional pressure. Also, there is no need of encapsulated adjuvants or a catalyst that would be consumed when self-healing. Therefore, the poly(alkylene carbonate) mixtures described herein do not wear out this surprising properties, and will display self-healing in an unlimited number of damage events.

Thus, in a first aspect the present disclosure is directed to the use of a mixture comprising a poly(alkylene carbonate) and a non-polymeric organic molecule having a molecular weight below 1,000 Da as a self-healing material.

Due to the surprising rapid self-healing behaviour of the poly(alkylene carbonate) mixtures of the disclosure, it is only required that the damaged areas are put together in contact. It is thus a second aspect of the disclosure a method for healing a damaged mixture comprising poly(alkylene carbonate) and a non-polymeric organic molecule having a molecular weight below 1,000 Da, comprising the step of arranging the damaged parts of the mixture to be in physical contact with each other.

The benefits of the poly(alkylene carbonate) mixtures used in the present disclosure are realized by the addition of widely accessible and economic organic molecules. It is thus a third aspect of the present disclosure the use of a non-polymeric organic molecule having a molecular weight below 1,000 Da to impart self-healing behaviour to a mixture comprising a poly(alkylene carbonate), preferably polypropylene carbonate (PPC). It is a further aspect of the disclosure a method for preparing a self-healing material that comprises preparing a mixture of a poly(alkylene carbonate) and a non-polymeric organic molecule having a molecular weight below 1,000 Da.

### BRIEF DESCRIPTION OF THE DRAWINGS

FIGS. 1A, 1B and 1C: qualitative self-healing test of a mixture comprising diethyl phthalate as low molecular weight organic molecule and PPC, immediately after the cut was made, after 1 minute and after 10 minutes, respectively. See example 2 for more details.

FIGS. 2A and 2B: qualitative self-healing comparative test of a PPC only (no low molecular weight organic molecule added), immediately after the cut was made and after 10 minutes, respectively. See example 2 for more details.

FIG. 3A: Front view of the dimensions of the dumbbell-shaped specimen according to ISO 37 type 2 standard used in Example 3.

FIG. 3B: Side view of the dimensions of the dumbbell-shaped specimen according to ISO 37 type 2 standard used in Example 3.

FIG. 4: Picture showing the position of the cut made for testing self-healing in Example 3.

### DETAILED DESCRIPTION OF THE DISCLOSURE

### Definitions

Throughout the present disclosure weight percentage (“wt %”) is 100 times the relation in weight (e.g. in grams or kilograms) between the component specified, and the total weight of the mixture in the same units. Unless otherwise indicated, “wt %” refers to the total weight percentage of a given component with respect to the total weight of the mixture of the disclosure.

The term “self-healing” has the normal meaning provided in the art, and refers to the property by which a polymer totally or partially recovers its structure and properties after suffering damage (for example, cut, torn or tear), thereby recovering its physical integrity totally or partially, without the need of significant external aid. Thus, the self-healing properties of the polymers of the present disclosure do not require significant heat, pressure or other external forces.

By the term “mixture” should be understood a blend or combination of the components. Said mixture is obtained following any of the procedures mentioned in the specification below.

The term “alkyl” refers to a straight or branched hydrocarbon chain group consisting of carbon and hydrogen atoms, containing no unsaturation, having the number of carbon atoms indicated in each case, which is attached to the rest of the molecule by a single bond. The skilled person can use in each case different alkyl groups, for example, containing 1 to 24, 1 to 12 or 1 to 6 carbon atoms. Exemplary alkyl groups can be methyl, ethyl, n-propyl, i-propyl, n-butyl, t-butyl, n-pentyl, etc.

The term “alkenyl” refers to a straight or branched hydrocarbon chain group consisting of carbon and hydrogen atoms, containing at least one carbon-carbon double bond, having the number of carbon atoms indicated in each case, which is attached to the rest of the molecule by a single bond. The skilled person can use in each case different alkenyl groups, for example, containing 1 to 24, 1 to 12 or 1 to 6 carbon atoms. Exemplary alkenyl groups can be vinyl, allyl, butenyl (e.g. 1-butenyl, 2-butenyl, 3-butenyl), pentenyl (e.g. 1-pentenyl, 2-pentenyl, 3-pentenyl, 4-pentenyl,), hexenyl (e.g. 1-hexenyl, 2-hexenyl, 3-hexenyl, 4-hexenyl, 5-hexenyl,), butadienyl, pentadienyl (e.g. 1,3-pentadienyl, 2,4-pentadienyl), hexadienyl (e.g. 1,3-hexadienyl, 1,4-hexadienyl, 1,5-hexadienyl, 2,4-hexadienyl, 2,5-hexadienyl), 2-ethylhexenyl (e.g. 2-ethylhex-1-enyl, 2-ethylhex-2-enyl, 2-ethylhex-3-enyl, 2-ethylhex-4-enyl, 2-ethylhex-5-enyl,), 2-propyl-2-butenyl, 4,6-Dimethyl-oct-6-enyl.

The term “alkynyl” refers to a straight or branched hydrocarbon chain group consisting of carbon and hydrogen atoms, containing at least one carbon-carbon triple bond, having the number of carbon atoms indicated in each case, which is attached to the rest of the molecule by a single bond. The skilled person can use in each case different alkenyl groups, for example, containing 1 to 24, 1 to 12 or 1 to 6 carbon atoms. Exemplary alkenyl groups can be ethynyl, propynyl (e.g. 1-propynyl, 2-propynyl), butynyl (e.g. 1-butynyl, 2-butynyl, 3-butynyl), pentynyl (e.g. 1-pentynyl, 2-pentynyl, 3-pentynyl, 4-pentynyl,), hexynyl (e.g. 1-hexynyl, 2-hexynyl, 3-hexynyl, 4-hexynyl, 5-hexynyl,), methylpropynyl, 3-methyl-1-butynyl, 4-methyl-2-heptynyl, and 4-ethyl-2-octynyl.

The term “cycloalkyl” refers to a saturated carbocyclic ring having the number of carbon atoms indicated in each case. Suitable cycloalkyl groups include, but are not limited to cycloalkyl groups such as cyclopropyl, cyclobutyl, cyclopentyl or cyclohexyl.

The term “aryl” refers to an aromatic hydrocarbon group having the number of carbon atoms indicated in each case, such as phenyl or naphthyl.

The term “arylalkyl” refers to an aryl group linked to the rest of the molecule through an alkyl group, and having the number of atoms indicated in each case. Exemplary arylalkyl moieties are benzyl and phen ethyl.

The terms “alkylene oxide”, “alkyleneoxide”, “epoxide” or “oxirane” are all considered equivalent and refer to an alkyl group as defined above comprising at least one epoxide functional group.

The term “alcoxyl” refers to a radical of the formula —ORa where Ra is an alkyl, alkenyl, alkynyl, aryl or arylalkyl radical as defined above, e.g., methoxy, ethoxy, propoxy, benzyloxy etc.

The term “alcoxylalkyl” refers to an alkyl group as defined above substituted with an alcoxyl group, wherein said alkoxyl group can include further alkoxyl groups. It can be for example a group having the formula —O—(R—O)g-R, wherein each R is independently selected from a C₁-C₁₂ alkyl group, preferably a C₁-C₄ alkyl group, and g is a number selected from 1, 2, 3, 4, 5 and 6. Examples of alcoxylalkyl groups are methoxymethyl, ethoxymethyl, propoxymethyl, methoxyethyl, ethoxyethyl, methoxypropyl, ethoxypropyl or CH₃—O—CH₂—CH₂—O—CH₂—CH₂—O—.

The term “aryloxy” refers to an aryl group as defined above attached to the molecule through an oxygen atom, that is, a residue of formula Aryl-O—. The term “alkyloxy” refers to an alkyl group as defined above attached to the molecule through an oxygen atom, that is, a residue of formula Alkyl-O—.

The term “arylalkyloxy” refers to a residue comprising an aryl residue attached to an alkyl residue, it attached to the rest of the molecule through an oxygen atom, that is, a residue of formula Aryl-Alkyl-O—.

The term “cycloalkylene oxide” or “cycloalkyleneoxide” refers to a cycloalkyl group as defined above comprising at least one epoxide functional group.

The term “styreneoxide” refers to a styrene skeleton (Ph-CH═CH₂) wherein the double bond has been substituted by an epoxide functional group.

Throughout the present disclosure, the number of carbon atoms may be symbolized by “Cₐ-C_{b}”, the number of carbon atoms being in each case comprised between “a” and “b”, both included. For example, “(C₆-C₂₀) aryl (C₁-C₂₀) alkyloxy” refers to an aryl residue comprising 6 to 20 carbon atoms, including 6 and 20; attached to an alkyl residue having between 1 and 20 carbon atoms, including 1 and 20; it attached to the rest of the molecule through an oxygen atom.

### Poly(alkylene Carbonates)

The poly(alkylene carbonates), also referred to as “PAC” or “polyalkylene carbonate”, used in the disclosure are generally known by the skilled person. The general description of the present disclosure is provided to aid the skilled person in choosing the best alternatives in each case. For example, PAC's useful in the disclosure of the present disclosure are described in applications such as WO 2008/136591 A1, WO 2010/013948, WO 2012/027725 or U.S. Pat. No. 9,346,951, which include different families and species of PACs and the methods to prepare them. Many of them are also commercially available from different vendors. Exemplary products are those of the QPAC® family of Empower Materials, including QPAC® 25 poly(ethylene carbonate), QPAC® 40 poly(propylene carbonate), QPAC® 100 poly(propylene/cyclohexene carbonate), and QPAC® 130 poly(cyclohexene carbonate) or QPAC® 60 poly(butylene carbonate). Also, Saudi Aramco sells PPC under the trademark Converge®.

The PACs of the present disclosure are typically prepared by a copolymerization reaction of carbon dioxide, and at least one alkylene oxide. In the present disclosure alkylene oxides are typically selected from the group consisting of (C₂-C₂₀)alkyleneoxide substituted or unsubstituted with halogen, (C₁-C₂₀)alkyloxy, (C₆-C₂₀)aryloxy, or (C₆-C₂₀)aryl(C₁-C₂₀)alkyloxy; (C₄-C₂₀)cycloalkyleneoxide substituted or unsubstituted with halogen, (C₁-C₂₀)alkyloxy, (C₆-C₂₀)aryloxy, or (C₆-C₂₀)aryl(C₁-C₂₀)alkyloxy; and (C₈-C₂₀)styreneoxide substituted or unsubstituted with halogen, (C₁-C₂₀)alkyloxy, (C₆-C₂₀)aryloxy, (C₆-C₂₀)aryl(C₁-C₂₀)alkyloxy.

The alkylene oxide may be one or two or more selected from the group consisting of ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrin, epichlorohydrin, epibromohydrin, glycidyl methyl ether, glycidyl ethyl ether, glycidyl normal propyl ether, glycidyl sec-butyl ether, glycidyl normal or isopentyl ether, glycidyl normal hexyl ether, glycidyl normal heptyl ether, glycidyl normal octyl or 2-ethyl-hexyl ether, glycidyl normal or isononyl ether, glycidyl normal decyl ether, glycidyl normal dodecyl ether, glycidyl normal tetradecyl ether, glycidyl normal hexadecyl ether, glycidyl normal octadecyl ether, glycidyl normal icosyl ether, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxidenorbornene, limonene oxide, dieldrin, 2,3-epoxidepropylbenzene, styrene oxide, phenylpropylene oxide, stilbene oxide, chlorostilbene oxide, dichlorostilbene oxide, 1,2-epoxy-3-phenoxypropane, benzyloxymethyl oxirane, glycidyl-methylphenyl ether, chlorophenyl-2,3-epoxidepropyl ether, epoxypropyl methoxyphenyl ether, biphenyl glycidyl ether, glycidyl naphthyl ether, glycidol acetic acid ester, glycidyl propionate, glycidyl butanoate, glycidyl normal pentanoate, glycidyl normal hexanoate, glycidyl hetanoate, glycidyl normal octanoate, glycidyl 2-ethylhexanoate, glycidyl normal nonanoate, glycidyl normal decanoate, glycidyl normal dodecanoate, glycidyl normal tetradecanoate, glycidyl normal hexadecanoate, glycidyl normal octadecanoate, and glycidyl icosanoate.

The poly(alkylene carbonate) according to an exemplary embodiment of the present disclosure may be poly(alkylene carbonate) represented by Formula (A)

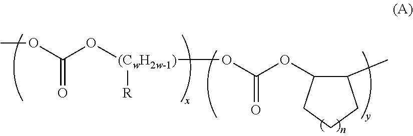

wherein w is an integer selected from 1, 2, 3, 4, 5, 6, 7, 8, 9 and 10, x is an integer selected from the group comprised between 5 and 100, y is an integer selected from the group comprised between 0 and 100, n is an integer selected from 1, 2 or 3, and R is hydrogen, (C₁-C₄)alkyl, or —CH₂—O—(C₁-C₈)alkyl. Thus, the term “alkylene” in the poly(alkylene carbonate) may include ethylene, propylene, 1-butylene, cyclohexene oxide, alkylglycidyl ether, n-butyl, and n-octyl, but is not limited thereto.

Therefore, the PACs of the present disclosure can be based, for example, on a C₂-C₆ oxirane, for example, a C₂, a C₃ or a C₄, or mixtures thereof, such as poly(ethylene carbonate) (PEC), poly(propylene carbonate) (PPC—see for example, Luinstra G. A.; Borchardt E., Adv. Polym. Sci. (2012) 245: 29-48 and Luinstra, G. A., Polymer Reviews, (2008) 48:192-5 219), poly(butylene carbonate), or poly(hexylene carbonate). Examples of PACs may include poly(cyclohexene carbonate), poly(norbornene carbonate) or poly(limonene carbonate). The PAC can be a poly(propylene carbonate), poly(ethylene carbonate), or mixtures thereof. Therefore, the present disclosure also includes mixtures of different PACs. Such mixtures can be, for example, PACs comprising units of PPC and PEC, or PPC or PEC mixed with other PACs, such as poly(buytylene carbonate), poly(hexylene carbonate), poly(cyclohexene carbonate), poly(norbornene carbonate) or poly(limonene carbonate).

In the present disclosure, a weight average molecular weight of the poly(alkylene carbonate) is not limited, but may be preferably in the range between 1,000 and 1,000,000 Da, preferably between 2,000 and 700,000 Da, for example, between 500,000 Da and 900,000 Da, for example, between 2,000 Da and 350,000 Da, between 10,000 Da and 250,000 Da, for example, between 15,000 Da and 200,000 Da, more preferably between 20,000 and 500,000 Da, even more preferably from 20,000 to 250,000 Da, for example, between 20,000 Da and 200,000 Da, for example, between 1,000 Da and 3,000 Da, for example, between 1,000 Da and 2,000 Da. The values of the weight-average molecular weights (Mw) are determined against polystyrene standards by gel-permeation chromatography (GPC) using a Bruker 3800 equipped with a deflection RI detector. Tetrahydrofuran at 1 mL/min flow rate was used as eluent at room temperature.

The most common PACs, preferred in the present disclosure, are poly(propylene carbonate), poly(ethylene carbonate) and mixtures thereof, more preferably, poly(propylene carbonate) (PPC). The poly(propylene carbonate) is the product resulting from copolymerising CO₂ with propylene oxide in the presence of a catalyst. Said reaction provides a compound containing a primary repeating unit having the following structure (B)

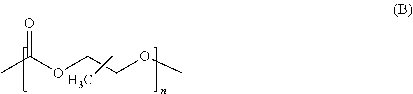

The poly(propylene carbonate) typically has a weight average molecular weight between 1,000 and 1,000,000 Da, between 1,000 and 500,000 Da. For example, a weight average molecular weight ranging from 10,000 to 500,000 Da, for example from 20,000 to 250,000 Da, for example, from 20,000 to 200,000 Da, for example, between 500,000 Da and 850,000 Da.

The poly(propylene carbonate) can be obtained by copolymerization of CO₂ and propylene oxide in the presence of transition metal catalysts, such as metal salen catalysts, for example cobalt salen catalysts or zinc glutarate catalysts. In addition to the methods described in the prior patent applications described above, further suitable catalysts and methods include those mentioned, for example, in WO 2010/022388, WO 2010/028362, WO 2012/071505, U.S. Pat. Nos. 8,507,708, 4,789,727, Angew. Chem. Int., 2003, 42, 5484-5487; Angew. Chem. Int., 2004, 43, 6618-6639; and Macromolecules, 2010, 43, 7398-7401.

It is preferred that the poly(propylene carbonate) has a high percentage of carbonate linkages. Preferably, the poly(propylene carbonate) has on average more than about 75% of adjacent monomer units connected via carbonate linkages and less than about 25% of ether linkages. More preferably, the poly(propylene carbonate) has on average more than about 80% of adjacent monomer units connected via carbonate linkages, even more preferably more than 85%, and most preferably more than 90%.

The percentage of carbonate linkages in poly(propylene carbonate) (as monomer units) was determined by means of ¹H-NMR (Bruker AV III HD 500, 500 MHz, pulse program zg30, waiting time d1: 1s, 120 scans). The sample was dissolved in deuterated chloroform. The relevant resonances in the ¹H-NMR (based on TMS=0 ppm) are as follows: carbonate linkages=1.35-1.25 ppm (3H); ether linkages=1.25-1.05 ppm (3H).

Considering the resonance areas, the carbonate linkages in the polymer chain was measured according to the following formula:

Percentage carbonate linkage=F(1,35−1,25)×100/(F(1.35−1.25)+F(1.25−1.05))

### Wherein:

F(1.35-1.25): resonance area at 1.35-1.25 ppm for carbonate groups (corresponds to 3H atoms);

F(1.25-1.05): resonance area at 1.25-1.05 ppm for ether groups (corresponds to 3H atoms).

Also a poly(ethylene carbonate) is suitable in the mixtures of the disclosure. The poly(ethylene carbonate), also referred to as PEC, is the resulting product of copolymerising CO₂ with ethylene oxide in the presence of a catalyst. Said reaction provides a compound containing a primary repeating unit having the following structure (C):

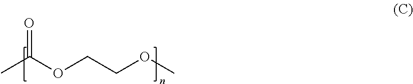

The poly(ethylene carbonate) typically has a weight average molecular weight between 1,000 and 500,000 Da. For example, a weight average molecular weight ranging from 10,000 to 300,000 Da, for example, from 20,000 to 250,000 Da, for example, from 80,000 to 200,000 Da.

It is preferred that the poly(ethylene carbonate) has a high percentage of carbonate linkages. Preferably, the poly(ethylene carbonate) has on average more than about 75% of adjacent monomer units connected via carbonate linkages and less than about 25% of ether linkages. More preferably, the poly(ethylene carbonate) has on average more than about 80% of adjacent monomer units connected via carbonate linkages, even more preferably more than 85%, and most preferably more than 90%.

### Low Molecular Weight Organic Molecules

The inventors have found that low molecular weight organic molecules can have a surprising impact in the poly(alkylene carbonates) with which they are mixed. Said low molecular weight organic molecules have a molecular weight below 1,000 Da. These low molecular weight organic molecules are non-polymeric molecules, that is, they have a defined molecular weight. Not being polymers, they are not prepared by polymerization, that is, the repeated reaction between one or more organic molecules. Typical organic molecules used in the disclosure may have a molecular weight comprised between 50 Da and 750 Da, for example, between 60 Da and 650 Da, for example, between 60 Da and 600 Da.

The inventors have observed that the dipole moment of the low molecular weight organic molecules can be above 0.5 D (debye), for example above 1 D, for example above 2 D. Typical values of the low molecular weight organic molecules used are comprised between 0.5 D and 10 D.

The inventors have also observed that the Hansen solubility parameter (MPa^{0.5}) can be above 2 MPa^{0.5} for example, above 4 MPa^{0.5}, for example, above 5 MPa^{0.5}, for example above 7 MPa^{0.5}, for example between 5 MPa^{0.5}H and 25 MPa^{0.5}, for example between 5 MPa^{0.5}H and 10 MPa^{0.5}, for example between 5 MPa^{0.5}H and 15 MPa^{0.5}. And the hydrogen bonding component of Hansen solubility parameter (6 h or SPh, MPa^{0.5}) can be above 1 MPa^{0.5}, for example above 2 MPa^{0.5}, for example between 2.5 and 12 MPa^{0.5}. The Hansen solubility parameter and the hydrogen bonding component of Hansen solubility parameter are calculated according the method described in Hansen, Charles (2007) Hansen Solubility Parameters: A user's handbook, Second Edition. Boca Raton, Fla.: CRC Press (ISBN 978-0-8493-7248-3), concretely using the group contribution method described in chapter 1 thereof, and applying the group values of Table 1.1 (pages 10-11); in case a value is given as a range in Table 1.1, the highest value was chosen.

Also, better results are obtained using non-polymeric organic molecule having a molar volume of less than 700 cm³/mol, for example, less than 600 cm³/mol. For example, the molar volume of the non-polymeric organic molecule can be comprised between 5 cm³/mol and 600 cm³/mol. Without wanting to be bound by theory, the inventors believe that the non-polymeric low molecular weight organic molecules used in the present disclosure intercalate between the chains of poly(alkylene carbonate), allowing the later to easily slide and thus readily create new interactions between chains. Thus, better self-healing properties are obtained when the non-polymeric organic molecule has an appropriate molecular weight (i.e. less than 1,000 Da), an appropriate Hansen solubility parameter, preferably 5 MPa^{0.5} or more, and molar volume, preferably less than 700 cm³/mol. Preferably, the non-polymeric organic molecule has a molar volume comprised between 5 cm³/mol and 600 cm³/mol and a Hansen parameter comprised between 5 MPa^{0.5} and 25 MPa^{0.5}.

The structure of the non-polymeric low molecular weight organic molecules for which this self-healing behaviour has been observed is surprisingly wide. Organic molecules are considered in the present disclosure molecules having as principal components hydrogen and carbon, for example, having a formula CₙH_{2n+z-z-y}XₐY_{b}, wherein “n” represents the number of carbon atoms, “z” is a number selected from 1, 2, 3, 4, 5, 6, 7, 8, 9 or 10, “a” represent the number of heteroatoms (X), i.e. an atoms that are different from carbon or hydrogen, and “b” represents the number of insaturations (Y) (e.g. double bonds) and cycles present in the molecule. It is preferred that the low molecular weight organic molecules of the present disclosure comprise at least one heteroatom selected from the group consisting of nitrogen, sulphur, phosphorus and oxygen, or mixtures thereof, preferably, at least one oxygen. The inventors have observed that PAC's displays self-healing when mixed with low molecular weight organic molecules having, for example, at least two oxygen groups, for example, between 2 and 10, for example, between 2 and 8. Said oxygen groups can be in the form of different functional groups, for example, as an ester, a carbonate, a phosphate, an ether or an amide. For example, said low molecular weight organic molecules typically display one, two, three or more esters, carbonates, ethers or combinations of said groups, for example in the form of benzoate or acetate groups.

For example, low molecular weight organic molecules suitable for the providing the self-healing mixtures of the disclosure are highly oxidized aromatic compounds. Representative embodiments of such molecules are the compounds of formula (I)

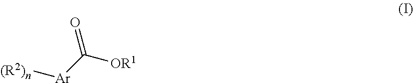

wherein
Ar represents a C₆-C₂₄ aryl residue;
R¹ is selected from the group consisting of a C₁-C₂₄ alkyl, C₂-C₂₄ alkenyl, C₂-C₂₄ alkynyl, C₁-C₂₄ alcoxyl, C₂-C₂₄ alcoxylalkyl, C₆-C₁₅ aryl, C₇-C₁₅ arylalkyl, optionally substituted with 1, 2, 3 or 4 groups independently selected from those of formula —O—(O═C)—(C₆-C₁₅ Aryl), preferably benzoate;
R² is selected from the group consisting of a C₁-C₂₄ alkyl, C₂-C₂₄ alkenyl, C₂-C₂₄ alkynyl, C₁-C₂₄ alcoxyl, C₂-C₂₄ alcoxylalkyl, C₆-C₁₅ aryl, C₇-C₁₅ arylalkyl, —OH, —(C═O)—OR¹ and —OR¹, wherein R¹ can be as defined above; and
n is a number selected from 0, 1, 2, 3, 4 or 5, preferably, 0, 1 or 2.

The inventors have found that low molecular weight molecules of formula (I) having carboxylate groups attached to an aryl group impart self-healing properties to the poly(alkylene carbonate) mixtures of the present disclosure. Typically, said aryl group is a C₆-C₂₄ aryl residue, preferably a C₆-C₁₅ aryl residue, for example a C₆-C₁₀ aryl residue. Examples of individual residues are benzene, anthracene, phenanthrene, tetralin or indane.

R¹ can be for example C₁-C₂₄ alkyl or C₂-C₂₄ alkenyl, for example C₂-C₁₂ alkyl or C₂-C₁₂ alkenyl, or C₂-C₁₀ alkyl or C₂-C₁₀ alkenyl.

Thus, the present disclosure describes also mixtures of a poly(alkylene carbonate), preferably a poly(propylene carbonate) (PPC), with a compound of formula (I), said compound of formula (I) having a molecular weight below 1,000 Da and being present in amounts between 1 wt % and 25 wt % with respect to the total weight of the mixture, for example, between 5 wt % and 15 wt % with respect to the total weight of the mixture, wherein the lower end of the range can be 6 wt %, 7 wt % or 8 wt % with respect to the total weight of the mixture, and the upper end of the range can be 11 wt %, 12 wt %, 13 wt %, or 14 wt % with respect to the total weight of the mixture.

A preferred embodiment of the compounds of formula (I) are the compounds of formula (II)

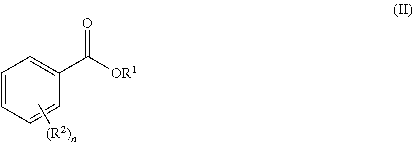

wherein R¹, R² and n are as defined above.

Further exemplary embodiments of the compounds of formula (I) are the compounds of formula (III)

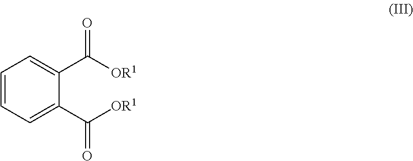

wherein each R¹ is as defined elsewhere in the present disclosure. In an exemplary embodiment, both R¹ in a compound of formula (III) are the same, preferably selected from the group consisting of C₁-C₂₄ alkyl and C₂-C₂₄ alkenyl, for example from C₁-C₁₆ alkyl and C₂-C₁₆ alkenyl, for example from C₁-C₁₂ alkyl and C₂-C₁₂ alkenyl.

Further exemplary embodiments of the compounds of formula (I) used in the present disclosure are the compounds of formula (IV)

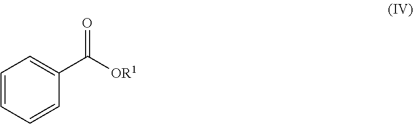

wherein R¹ is as defined elsewhere in the present disclosure. The compounds of formula (IV) can also be those wherein R¹ is selected from the group consisting of a C₁-C₂₄ alkyl, C₂-C₂₄ alkenyl, C₁-C₂₄ alcoxyl, C₂-C₂₄ alcoxylalkyl and C₆-C₁₅ aryl, substituted with 1, 2, 3 or 4 groups independently selected from those of formula —O—(O═C)—(C₆-C₁₅-Aryl), preferably benzoate. Further exemplary compounds of formula (IV) are those wherein R¹ is selected from the group consisting of a C₁-C₁₂ alkyl, C₂-C₁₂ alkenyl, C₁-C₁₂ alcoxyl and C₂-C₁₂ alcoxylalkyl, substituted with 1, 2, 3 or 4 groups independently selected from those of formula —O—(O═C)—(C₆-C₁₅-Aryl), preferably benzoate.

The compounds of formula (I) have a molecular weight below 1,000 Da, and typical examples have between 50 Da and 750 Da, for example, between 100 Da and 650 Da, for example, between 100 Da and 600 Da.

Further molecules found appropriate in the mixtures of the disclosure are low molecular weight carbonates, for example, the compounds of formula (V)

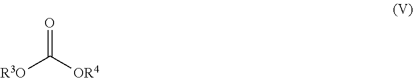

wherein R³ and R⁴ are each selected from the group consisting of C₁-C₂₄ alkyl and C₂-C₂₄ alkenyl; which, together with the carbonate moiety, may form a ring. Such rings can be typically 5, 6 or 7 membered rings. R³ and R⁴ can each be selected from a C₁-C₂₄ alkyl, for example, a C₁-C₆ alkyl or a C₁-C₄ alkyl, for example, methyl, ethyl, propyl, iso-propyl, butyl, iso-butyl, sec-butyl or tert-butyl.

The compounds of formula (V) have a molecular weight below 1,000 Da, and typical examples have between 50 Da and 750 Da, for example, between 60 Da and 700 Da, for example, between 60 Da and 650 Da, for example, between 90 Da and 550 Da, for example, between 100 Da and 450 Da.

Thus, the present disclosure describes also mixtures of a poly(alkylene carbonate), preferably a poly(propylene carbonate) (PPC), with a compound of formula (V), said compound of formula (V) having a molecular weight below 1,000 Da and being present in amounts between 1 wt % and 25 wt % with respect to the total weight of the mixture, for example, between 5 wt % and 15 wt % with respect to the total weight of the mixture, wherein the lower end of the range can be 6 wt %, 7 wt % or 8 wt % with respect to the total weight of the mixture, and the upper end of the range can be 11 wt %, 12 wt %, 13 wt %, or 14 wt % with respect to the total weight of the mixture.

Further molecules found appropriate for the mixtures of the disclosure are a first group of low molecular weight C₁-C₆₀ alkanes, C₂-C₆₀ alkenes or C₂-C₆₀ alkynes, for example, a C₁-C₂₄ alkane, a C₂-C₂₄ alkene, or a C₂-C₂₄ alkyne, more specifically a C₃-C₂₄ alkane, a C₄-C₂₄ alkene, or a C₄-C₂₄ alkyne, more specifically a C₃-C₁₆ alkane, a C₄-C₁₆ alkene, or a C₄-C₁₆ alkyne; which are substituted with 1, 2, 3, 4, 5 or 6, preferably, 1, 2, 3 or 4, groups of formula —O—(C═O)—R⁵ and/or of formula —(C═O)—O—R⁵, wherein R⁵ is selected from the group consisting of C₁-C₆ alkyl, C₂-C₆ alkenyl, C₂-C₆ alkynyl, C₁-C₂₄ alcoxyl, C₂-C₂₄ alcoxylalkyl, C₆-C₁₅ aryl and C₇-C₁₅ arylalkyl. R⁵ in each case can be the same or different, typically the same, and is for example an acetate group. Said alkane, alkene or alkyne may be also optionally substituted with 1, 2, 3 or 4 groups selected from the group consisting of —OR⁶, —N(R⁷)(R⁸), and —SR⁶, wherein each of R⁶, R⁷ and R⁸ is independently selected from hydrogen, C₁-C₆ alkyl, C₂-C₆ alkenyl and C₂-C₆ alkynyl, preferably selected from hydrogen and C₁-C₆ alkyl. Said compounds have a molecular weight below 1,000 Da, and typical examples have between 50 Da and 750 Da, for example, between 100 Da and 750 Da, for example, between 150 Da and 650 Da.

Thus, the present disclosure describes also mixtures of a poly(alkylene carbonate), preferably a poly(propylene carbonate) (PPC), with said oxidized low molecular weight C₁-C₆₀ alkane, C₂-C₆₀ alkene or C₂-C₆₀ alkyne, said compound having a molecular weight below 1,000 Da and being present in amounts between 1 wt % and 25 wt % with respect to the total weight of the mixture, for example, between 5 wt % and 15 wt % with respect to the total weight of the mixture, wherein the lower end of the range can be 6 wt %, 7 wt % or 8 wt % with respect to the total weight of the mixture, and the upper end of the range can be 11 wt %, 12 wt %, 13 wt %, or 14 wt % with respect to the total weight of the mixture.

Further molecules found appropriate for the mixtures of the disclosure are a second group of low molecular weight C₁-C₆₀ alkanes, for example, C₁-C₂₄ alkane, more specifically C₃-C₂₄ alkane; which are substituted with 1, 2, 3, 4, 5 or 6, preferably, 1, 2, 3 or 4, groups of formula —O—(C═O)—R¹⁹ and/or of formula —(C═O)—O—R¹⁹, wherein R¹⁹ is selected from the group consisting of C₁-C₂₄ alkyl, C₁-C₂₄ alcoxyl, and C₂-C₂₄ alcoxylalkyl. Said second group of low molecular weight C₁-C₆₀ alkanes have a molecular weight below 1,000 Da, and typical examples have between 50 Da and 575 Da, for example, between 100 Da and 750 Da, for example, between 150 Da and 600 Da.

Thus, the present disclosure describes also mixtures of a poly(alkylene carbonate), preferably a poly(propylene carbonate) (PPC), with said second group of low molecular weight C₁-C₆₀ alkanes, said compounds having a molecular weight below 1,000 Da and being present in amounts between 1 wt % and 25 wt % with respect to the total weight of the mixture, for example, between 5 wt % and 15 wt % with respect to the total weight of the mixture, wherein the lower end of the range can be 6 wt %, 7 wt % or 8 wt % with respect to the total weight of the mixture, and the upper end of the range can be 11 wt %, 12 wt %, 13 wt %, or 14 wt % with respect to the total weight of the mixture.

Further molecules found appropriate for the mixtures of the disclosure are low molecular weight of formula (VI)

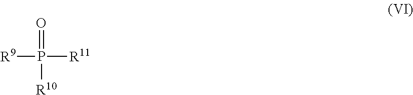

wherein R⁹, R¹⁰ and R¹¹ are each selected from the group consisting of C₁-C₂₄ alkyl, C₂-C₂₄ alkenyl, C₂-C₂₄ alkynyl, C₁-C₂₄ alcoxyl, C₂-C₂₄ alcoxylalkyl, C₆-C₁₅ aryl and C₇-C₁₅ arylalkyl. Each of R⁹, R¹⁰ and R¹¹ can thus be the same of different, preferably the same. Typically, each of R⁹, R¹⁰ and R¹¹ can be a C₁-C₁₂ alkyl, C₂-C₁₂ alkenyl, C₂-C₁₂ alkynyl, C₁-C₁₂ alcoxyl, C₂-C₁₂ alcoxylalkyl, C₆-C₁₀ aryl and C₇-C₁₂ arylalkyl, more typically a C₂-C₁₂ alcoxyl. The compounds of formula (VI) have a molecular weight below 1,000 Da, and typical examples have between 100 Da and 800 Da, for example, between 200 Da and 700 Da, for example, between 250 Da and 650 Da.

Further molecules found appropriate for the mixtures of the disclosure are low molecular weight compounds of formula (VII)

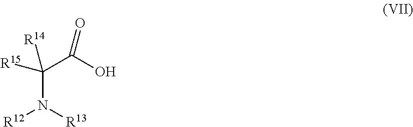

wherein R¹² and R¹³ are each selected from the group consisting of hydrogen, C₁-C₁₂ alkyl, C₂-C₁₂ alkenyl and —O—(C═O)—(C₁-C₁₂ alkyl); and

R¹⁴ and R¹⁵ are each selected from the group consisting of hydrogen, C₁-C₁₂ alkyl and C₂-C₁₂ alkenyl, each optionally substituted by a residue selected from the group consisting of —OR¹⁶, —N(R¹⁷)(R¹⁸), and —SR¹⁶, wherein each of R¹⁶, R¹⁷ and R¹⁸ is independently selected from hydrogen, C₁-C₆ alkyl, C₂-C₆ alkenyl and C₂-C₆ alkynyl, preferably selected from hydrogen and C₁-C₆ alkyl.

Compounds of formula (VII) can thus be considered as an amino acid (in their neutral form, although the zwitterion is also included in the scope of the application), for example, glycine, although highly substituted compounds of formula (VII) are preferred. It is typically preferred a compound of formula (VII) wherein at least one of R¹² and R¹³ is different form hydrogen. Also, typical compounds of formula (VII) are those wherein at least one of R¹⁴ and R¹⁵ is different from hydrogen.

A typical amino acid of formula (VII) used in the present disclosure is a low molecular weight compound of formula (VIII)

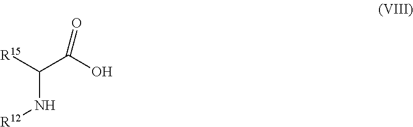

wherein R¹² and R¹⁵ have the meaning indicated above, preferably, wherein R¹² is selected from the group consisting of hydrogen and —O—(C═O)—(C₁-C₁₂ alkyl); and R¹⁵ is selected from the group consisting of C₁-C₁₂ alkyl and C₂-C₁₂ alkenyl, substituted by a residue selected from the group consisting of —OR¹⁶, —N(R¹⁷)(R¹⁸), and —SR¹⁶, wherein each of R¹⁶, R¹⁷ and R¹⁸ is independently selected from hydrogen and C₁-C₃ alkyl.

The compounds of formula (VII) have a molecular weight below 1,000 Da, and typical examples have between 50 Da and 400 Da, for example, between 350 Da and 600 Da, for example, between 300 Da and 700 Da.

Thus, the present disclosure describes also mixtures of a poly(alkylene carbonate), preferably a poly(propylene carbonate) (PPC), with a compound of formula (VI) or of formula (VII) or of formula (VIII), said compound of formula (VI), (VII) or (VIII) having a molecular weight below 1,000 Da and being present in amounts between 1 wt % and 25 wt % with respect to the total weight of the mixture, for example, between 5 wt % and 15 wt % with respect to the total weight of the mixture, wherein the lower end of the range can be 6 wt %, 7 wt % or 8 wt % with respect to the total weight of the mixture, and the upper end of the range can be 11 wt %, 12 wt %, 13 wt %, or 14 wt % with respect to the total weight of the mixture.

Without wanting to be bound by theory, the inventors believe that the non-polymeric low molecular weight organic molecules used in the present disclosure intercalate between the chains of poly(alkylene carbonate), allowing the later to easily slide and thus readily create new interactions between chains. This new interactions are capable of filing gaps and thus give raise to the self-healing behaviour. It is thus preferably that the non-polymeric low molecular weight organic molecules used in the present disclosure do not react with the poly(alkylene carbonate). Therefore, it is preferable that the composition used according to the disclosure is one comprising a poly(alkylene carbonate) and a non-polymeric organic molecule having a molecular weight below 1,000 Da, wherein the non-polymeric organic molecule does not form covalent bonds with the poly(alkylene carbonate).

### Mixtures

The non-polymeric low molecular weight organic molecules can be incorporated into the mixture in a wide range of proportions. Typically, between 0.1 wt % and 30 wt % with respect to the total weight of the mixture. The inventors have observed that the self-healing behaviour can be achieved at very low and very high proportions. Typically, the composition will comprise between 1 wt % and 25 wt % with respect to the total weight of the mixture, for example, between 2 wt % and 20 wt % with respect to the total weight of the mixture, wherein the lower end of the range can be 3 wt %, 4 wt %, 5 wt %, 6 wt %, 7 wt % or 8 wt % with respect to the total weight of the mixture, and the upper end of the range can be 11 wt %, 12 wt %, 13 wt %, 14 wt %, 15 wt %, 16 wt %, 17 wt %, 18 wt % or 19 wt %.

The poly(alkylene carbonate) (or mixture thereof) can be incorporated into the mixture in a wide range of proportions. Typically, between 70 wt % and 99.9 wt % with respect to the total weight of the mixture. Typically, the composition will comprise between 75 wt % and 99 wt % with respect to the total weight of the mixture, for example, between 80 wt % and 98 wt % with respect to the total weight of the mixture, wherein the lower end of the range can be, for example, 80 wt %, 82 wt %, 85 wt %, 90 wt %, 94 wt % or 95 wt % with respect to the total weight of the mixture, and the upper limit as high as 80 wt %, 85 wt %, 86 wt %, 87 wt %, 88 wt %, 89 wt %, 90 wt %, 95 wt % or 99 wt %.

The mixtures used in the disclosure can comprise one or more poly(alkylene carbonates) and one or more non-polymeric low molecular weight organic molecules.

The poly(alkylene carbonate) mixtures used in the present disclosure can be prepared by conventional methods, for example, by mixing the components. Said components can be mixed in a mixer or chamber, such as a Haake chamber, at temperatures sufficient to molten the polymers, for example ranging from 20° C. to 250° C., typically between 100° C. and 200° C., during the time necessary to obtain a homogeneous mixture. The different additives, if any, can be added before or after mixing the poly(alkylene carbonate) and the low molecular weight organic molecule. This process can be carried out in an extruder or a speed mixer, for example, the Dual Asymmetric Centrifugal Laboratory (The SpeedMixer™ DAC 150.1 FV), preferably at 3,500 rpm for at least 3 minutes after heating in oven at 120° C.-130° C. for 30-60 minutes.

The inventors have observed that the self-healing behaviour only requires the presence of the non-polymeric low molecular weight organic molecules and the poly(alkylene carbonate). No further components are necessary to obtain a self-healing poly(alkylene carbonate). Thus, for example, it has been observed in the prior art that polyether carbonate polyol (PoPC) mixed with poly(alkylene carbonates) provide self-healing polymeric mixtures, which is not the object of the present disclosure. Thus, the present disclosure is preferably directed to the use of a self-healing material of a mixture comprising a poly(alkylene carbonate) and a non-polymeric organic molecule having a molecular weight below 1,000 Da, and wherein the mixture comprises less than 5 wt % of a polyether carbonate polyol having CO₂ groups randomly incorporated in the chemical structure thereof, wherein the content of CO₂ ranges from 0.5 to 40 wt %, based on the total weight of the polyether carbonate polyol. Thus, other components, such as PoPC are not necessary at all to obtain the self-healing mixture. Thus, the mixture of the disclosure may comprise no polyether carbonate polyol having CO₂ groups randomly incorporated in the chemical structure thereof, wherein the content of CO₂ ranges from 0.5 to 40 wt %, based on the total weight of the polyether carbonate polyol.

### Other Components of the Blend

The skilled person can choose among a wide variety of additives known in the art, for example, from Encyclopedia of Polymer Science and Engineering, 2nd Ed., vol. 14, p. 327-410 or other reference information.

The compositions of the disclosure may further comprise other additives frequently used in the preparation of polymers. The blends of the disclosure may comprise one or more further additives. Preferably, the blend of the disclosure comprises 0 to 5 wt % of one or more further additives, based on the total weight of the blend. In a particular embodiment, it comprises 0.01 to 5 wt % of one or more further additives, preferably 0.01 to 3 wt. %, more preferably 0.05 to 2 wt. %, even more preferably 0.05 to 0.5 wt. %. Examples of these additives include antioxidants, such as sterically hindered phenols, phosphites, thioethers or thioesters; rheology modifiers (flow agents), such as copolymers of ethylene with vinyl acetate or acrylic acid; stabilizers or antislipping agents, such as amide derivatives; colorants, such as titanium dioxide; fillers, such as talc, clay, silica and calcium carbonate.

The compositions of the disclosure can also comprise as an optional additive 0.005 to 5 wt % of at least one antioxidant, based on the total weight of the mixture, for example, 0.01 to 5 wt % of at least one antioxidant, preferably 0.01 to 3 wt %, more preferably 0.05 to 2 wt %, even more preferably 0.05 to 0.5 wt %. Said antioxidant can be selected from sterically hindered phenols, phosphites and mixtures thereof. Preferably, it is a mixture of a sterically hindered phenol and a phosphite. Sterically hindered phenols are well known to the skilled person in the art and refer to phenolic compounds which contain sterically bulky groups, such as tert-butyl, in close proximity to the phenolic hydroxyl group thereof. In particular, they may be characterized by phenolic compounds substituted with tert-butyl groups in at least one of the ortho positions relative to the phenolic hydroxyl group. Hindered phenols frequently used have tert-butyl groups in both ortho-positions with respect to the hydroxyl group. Representative hindered phenols include pentaerythritol tetrakis(3-(3,5-di-tert-butyl-4-hydroxyphenyl)propionate), 1,3,5-trimethyl-2,4,6-tris(3,5-di-tert-butyl-4-hydroxybenzyl) benzene, n-octadecyl-3(3,5-di-tert-butyl-4-hydroxyphenyl) propionate, 4,4′-rnethylenebis(4-rnethyl-6-tert-butylphenol), 4,4′-thiobis(6-tert-butyl-o-cresol), 6-(4-hydroxyphenoxy)-2,4-bis(n-ocytlthio)-1,3,5-triazine, 2,4, 6-tris(4-hydroxy-3,5-di-tertbutyl-phenoxy)-1,3,5-triazine, di-n-octadecyl-3,5-di-tert-butyl-4-hydroxybenzylphosphonate, 2-(n-octylthio)ethyl-3,5-d i-tert-butyl-4-hydroxybenzoate, and sorbitol hexa-(3,3,5-d i-tert-butyl-4-hydroxy-phenyl) propionate.

Phosphites are preferably aromatically substituted phosphites, preferably substituted or unsubstituted triphenyl phosphites. Examples of these phosphites include triphenyl phosphite, trisnonylphenyl phosphite, and tris(2,4-di-tert butylphenyl)-phosphite.

For example, the composition of the disclosure may comprise 0.05 to 0.5 wt % of at least one antioxidant selected from sterically hindered phenols, aromatically substituted phosphites and mixtures thereof. Preferably, the antioxidant is a mixture of a sterically hindered phenol and an aromatically substituted phosphite, e.g. a mixture of pentaerythritol tetrakis(3-(3,5-di-tert-butyl-4-hydroxyphenyl)propionate) and tris(2,4-di-tert-butylphenyl)-phosphite.

Further additives that can be included in the compositions of the disclosure can be selected from the following:
Stabilizers;
rheology modifiers, also known as flow agents, should the blend formulation require them for optimal processing properties—typically used at loadings of 0.2-2% by weight. These may be selected from a wide range of small molecules, oligomers and polymers compatible with the major blend components—typical flow agents for polyethylenes include ethylene copolymers with vinyl acetate or acrylic acid.
fillers for reducing cost, adding bulk, improving cohesive strength (forming an aggregate-matrix composite material) and altering properties; e.g., calcium carbonate, barium sulfate, talc, silica, carbon black, clays (e.g., kaolin);
UV stabilizers which protect the material against degradation by ultraviolet radiation;
pigments and dyes, e.g. cable-coating dye;
inorganic, organic and polymeric flame retardants and their synergists;
antistatic agents:
ferromagnetic particles, hygroscopic water-retaining materials, or other materials which can yield a composition which can be activated by microwave heating or magnetic induction; and/or
electrically conductive particles which can yield conductive materials for electric charge dissipation and for electric field stress control such as in high voltage cables and cable accessories
biocides for hindering bacterial growth.

### Articles of Manufacturing

The self-healing behaviour of the poly(alkylene carbonate) mixtures described in the present disclosure can be useful for different applications, for example, for the protection surface, in manufacturing of, in packaging, the manufacturing of leak-tight article, films, coatings, sealants or adhesives. For example, the mixtures of the disclosure can be used to manufacture coatings. Thus, the poly(alkylene carbonate) mixtures described in the present disclosure can be used in industries such as the automotive, pharmaceutical, medical, textile, construction, or furniture, amongst others. Other articles of manufacture that can be prepared with the resulting material include fibres, ribbons, sheets, tapes, pellets, tubes, pipes, catheters, weather-stripping, seals, gaskets, foams, and footwear. These articles can be manufactured using known equipment and techniques, such as, for example, injection, extrusion, thermoforming, lamination or 3D printing (additive manufacturing). Thus, the disclosure provides an article selected from the group consisting of a protection surface, a package, a leak-tight article, a film, a coating, a sealant and an adhesive. One of the advantageous properties of the mixtures of the disclosure is that they provide adequate tack without the need of additives. Thus, the mixtures of the disclosure can be one comprising no tackifying agents.

### EXAMPLES

### Example 1: Preparation of poly(alkylene Carbonate) Mixtures

The poly(alkylene carbonate) mixtures were prepared following conventional methods. The poly(alkylene carbonate) and the low molecular weight organic molecule were mixed in a Haake chamber until a melted homogenous mixture is obtained, typically at a temperature of approximately 170° C. and 50 rpm for at least 8 min.

In all cases the mixture comprised 90 wt % of a PAC, and 10 wt % of the non-polymeric low molecular weight organic molecule.

The poly(alkylene carbonates) were the following:

PPC1: >90% carbonate linkages, Mw=120,000 Da, polydispersity index 5
PEC1: >95% carbonate linkages, Mw=240,000 Da, polydispersity index 3.3
PPC2: >90% carbonate linkages, Mw=170,000 Da, polydispersity index 3
PPC3: >99% carbonate linkages, Mw=32,000 Da, polydispersity index 1.4

PPC1 and PEC1 were supplied by Empower Materials as QPAC40 and QPAC25; PPC2 was supplied by TaiZhou BangFeng Plastic Co., Ltd, whereas PPC3 was an experimental material prepared according to the procedures described in Angew. Chem. Int., 2003, 42, 5484-5487; Angew. Chem. Int., 2004, 43, 6618-6639; Macromolecules, 2010, 43, 7398-7401.

The non-polymeric low molecular weight organic molecules used are summarized in Table 1:

TABLE 1

| | Molecular | |
|---|---|---|
| Low molecular weight | Weight | |
| organic molecule | (g/mol) | Structure |
| Ethyl benzoate (EB) | 150 | 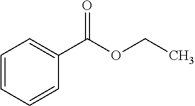 |
| Butyl 4-hydroxybenzoate (BHB) | 194 | 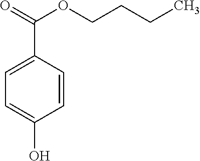 |
| Dipropylene glycol dibenzoate (GB) | 342 | 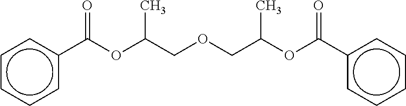 |
| Glycerol tribenzoate (GTB) | 404 | 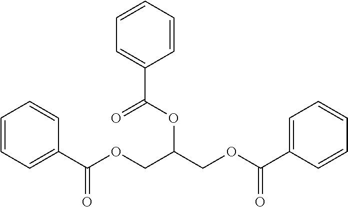 [SMILES: O=C(OCC(COC(=O)c1ccccc1)OC(=O)c1ccccc1)c1ccccc1] |
| Diethyl phthalate (DEP) | 222 | 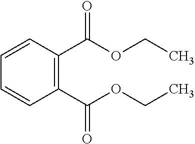 [SMILES: CCOC(=O)c1ccccc1C(=O)OCC] |
| Diallyl phthalate (DP) | 246 | 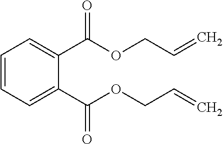 [SMILES: C=CCOC(=O)c1ccccc1C(=O)OCC=C] |
| Dimethyl carbonate (DMC) | 90 | 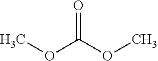 |
| Bis[2-(2- butoxyethoxy)ethyl] adipate (BEA) | 434 | 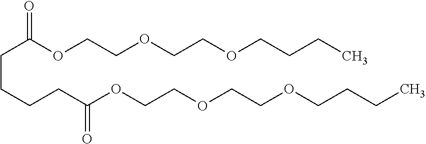 [SMILES: CCCCOCCOCCOC(=O)CCCCC(=O)OCCOCCOCCCC] |
| Tributyl 2-acetylcitrate (TAC) | 402 | 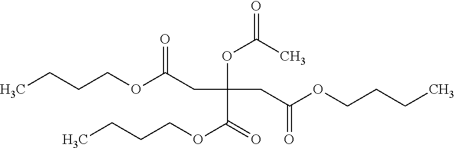 [SMILES: CCCCOC(=O)CC(CC(=O)OCCCC)(OC(C)=O)C(=O)OCCCC] |
| Triacetin (TC) | 218 | 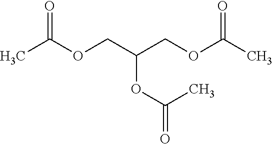 |
| Propylen glycol monomethyl acetate ether (PGA) | 132 | 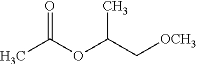 |
| Tributoxy ethyl phosphate (TEP) | 398 | 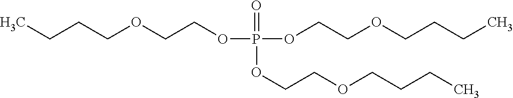 [SMILES: CCCCOCCOP(=O)(OCCOCCCC)OCCOCCCC] |
| Dioctyl phthalate (DOP) | 390 | 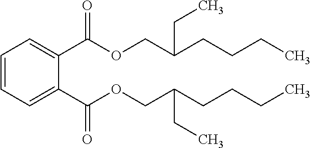 [SMILES: CCCCC(CC)COC(=O)c1ccccc1C(=O)OCC(CC)CCCC] |

In the following examples, each sample is named by the specific poly(alkylene carbonate) and organic molecule used. For example, PPC1/EB or PPC1+EB indicates a mixture of PPC1 (90%) and Ethyl benzoate (EB) (10%). In all the examples, samples comprise 90 wt % of the poly(alkylene carbonate) and 10 wt % of the non-polymeric low molecular weight organic molecule.

Table 2 below indicates the Hansen values and the molar volumes of the molecules in Table 1, and summarizes the parameters used for the calculation. SPd is the energy from dispersion forces between molecules. SPp is the energy from dipolar intermolecular force between molecules. SPh is the energy from hydrogen bonds between molecules. SP0 is the resulting Hansen parameter. All values are given in MPa^{0.5}.

TABLE 2

| Low molecular | | | | | Molar |
|---|---|---|---|---|---|
| weight organic | | | | | volume |
| molecule | SPd | SPp | SPh | SP0 | (cm³/mol) |
| EB | 8.4 | 1.9 | 3.3 | 9.2 | 139 |
| GTB | 9.3 | 1.7 | 3.8 | 10.2 | 299 |
| GB | 8.7 | 2.1 | 3.5 | 9.6 | 279.8 |
| DP | 9.0 | 2.2 | 4.1 | 10.2 | 169.8 |
| DEP | 7.7 | 1.8 | 3.7 | 8.7 | 206.6 |
| DOP | 7.8 | 1.0 | 2.8 | 8.3 | 379.6 |
| DMC | 5.0 | 3.9 | 4.6 | 7.9 | 88.8 |
| TC | 16.5 | 4.5 | 9.1 | 19.4 | 185.7 |
| TAC | 7.0 | 1.4 | 3.9 | 8.1 | 363.9 |
| PGA | 6.3 | 1.8 | 3.2 | 7.3 | 137.4 |
| TEP | 7.4 | 2.4 | 3.6 | 8.6 | 381.4 |
| BEA | 7.6 | 2.7 | 3.4 | 8.7 | 408 |
| BHB | 8.9 | 2.7 | 6.0 | 11.1 | 181.2 |

The calculations of SPd, SPp, SPh and SP0 were made using the group contribution method described in chapter 1 of Hansen, Charles (2007) Hansen Solubility Parameters: A user's handbook, Second Edition. Boca Raton, Fla.: CRC Press (ISBN 978-0-8493-7248-3), and applying the group values of Table 1.1 (pages 10-11); in case a value is given as a range in Table 1.1, the highest value was chosen. The molar volume was calculated using the group contribution method as described in chapter 1 of Hansen, Charles (2007) Hansen Solubility Parameters: A user's handbook, Second Edition. Boca Raton, Fla.: CRC Press (ISBN 978-0-8493-7248-3), and applying the molar volume values of Table 1.1 (pages 10-11; first column of the table); in case a value is given as a range in Table 1.1, the highest value was chosen.

### Example 2: Qualitative Confirmation of Self-Healing Behaviour

The poly(alkylene carbonate) mixtures so prepared were qualitatively tested for self-healing behaviour. A disc was prepared having a thickness of 2 mm and a diameter of 23 mm for each of the mixtures prepared in Example 1. A cut was made with a cutter through the middle of the specimen so as to obtain two separate portions. The two resulting portions were immediately put into contact after cutting through the edge that had been cut, and then allowed to stand at room temperature (under conditions humidity and temperature certified) for 5 seconds, 20 seconds, 40 seconds and 60 seconds applying a minimum pressure. The healing process was monitored visually. In all cases, visual inspection showed self-healing behavior confirmed by resistance shown when trying to separate both portions apart.

The results are summarized in Table 3:

TABLE 3

| | | Time to |
|---|---|---|
| | | Self- |
| | Self- | healing |
| Mixture | heal? | (s) |
| PPC1 only | NO | — |
| PPC1 + BHB | YES | 5 |
| PPC1 + GB | YES | 5 |
| PPC1 + EB | YES | 60 |
| PPC1 + DEP | YES | 5 |
| PPC1 + DP | YES | 40 |
| PPC + DMC | YES | 5 |
| PPC1 + BEA | YES | 5 |
| PPC1 + TAC | YES | 5 |
| PPC1 + TC | YES | 5 |
| PPC1 + PGA | YES | 5 |
| PPC1 + TEP | YES | 5 |
| PEC1 only | NO | — |
| PEC1 + DMC | YES | 5 |
| PEC1 + DEP | YES | 5 |
| PPC2 only | NO | — |
| PPC2 + DEP | YES | 5 |
| PPC3 only | NO | — |
| PPC3 + DEP | YES | 5 |

The mixtures of poly(alkylene carbonate) and the non-polymeric low molecular weight organic molecules display self-healing behaviour even after very short times at temperatures comprised between 15° C. and 60° C., preferably at room temperature. For example, the mixtures display self-heal after 10 minutes, or after 5 minutes or after only 60 seconds, preferably after 40 seconds, preferably after 30 seconds, more preferably after 5 seconds, under the conditions described above. This self-healing behaviour can manifest as a partial recovery of tensile strength, a partial recovery of the elastic modulus, or a partial recovery in other physical properties. The inventors have observed that recovery can even be appraised with the naked eye after a few seconds.

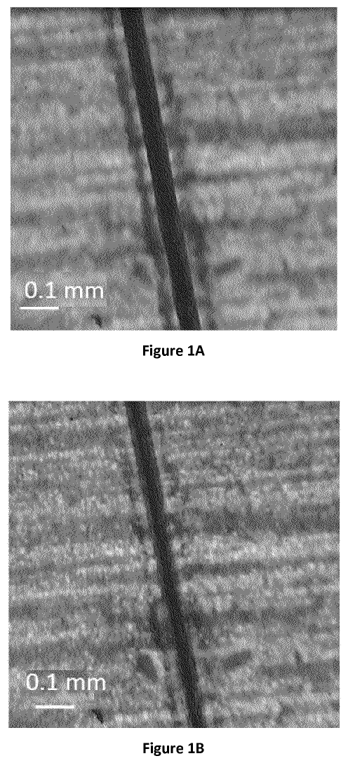

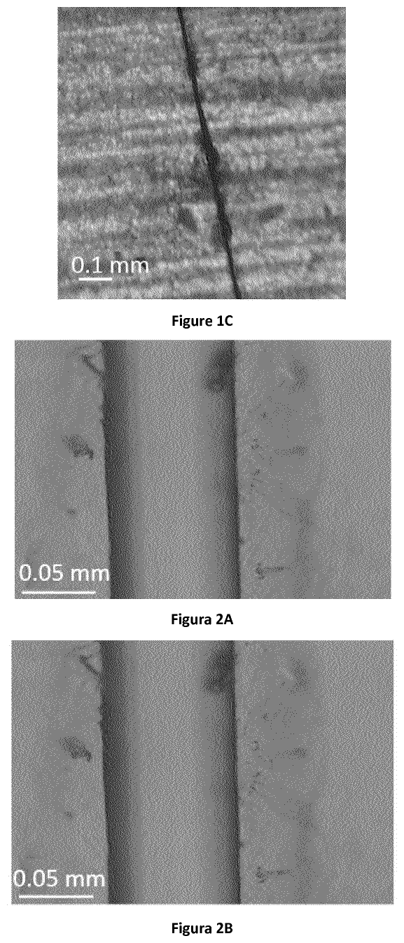

A second qualitative test was run under optical microcopy using a labolux 12 ME ST (Leizt Laborlux, Wetzlar, Germany) having a Jabalin Pro Series chamber and Cyberlinx software in order to capture images. The magnifications used were ×5 and ×10. A coating was tested by making a cut and observing the evolution over time. For the cut, a precision TQC pressure pencil was used (TQC.B.V, Molenbaan, Netherlands). A force of 18 N was used for all samples. In all cases a clear evolution towards healing could be observed. As way of example, FIGS. 1A, 1B and 1C (×5 magnification) show the results of mixture PPC1+DEP, immediately after the cut was made, after 1 minute and after 10 minutes, respectively. As way of comparison, FIGS. 2A and 2B (×10 magnification) show the evolution of PPC1 only for the same experiment. FIG. 2A is picture taken immediately after the cut was made and FIG. 2B after 10 minutes. It is evident from the comparison that PPC1 does not self-heal.

### Example 3: Self-Healing Behaviour of Dumbbell-Shaped Samples at Different Times

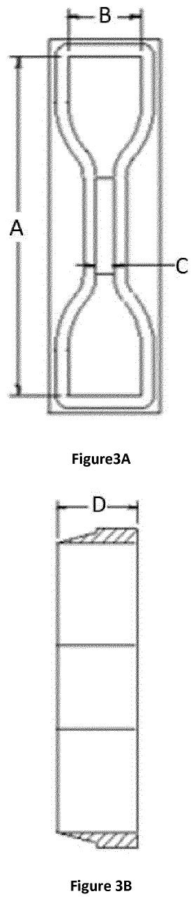

Also the self-healing efficiency was monitored in dumbbell-shaped specimens. Each mixture was molded in the form of dumbbell-shaped specimen with dimensions according to ISO 37 type 2 standard in order to perform the tensile strength measurements. As per FIGS. 3A and 3B the dimensions are as follows: A=75.00 mm, B=12.50 mm, C=4.00 mm, D=31.75 mm.

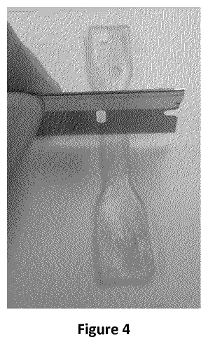

Some of the specimens were mechanically tested as pristine samples. The rest were tested after having been cut in half with a cutter (see FIG. 4), then mended for 15 seconds by simple contact and left on a flat surface for the periods of time as specified in Table 4.

The healing process was monitored visually, and the physical property indicated in each case was tested.

Tensile strength measurements were performed using an Instron universal testing machine under humidity of 50% and at a temperature of 20° C., and tensile strength vs. strain curves were monitored. The interface type of the Instron was a Series 42/43/4400. Briefly, the dumbbell-shaped specimens were stretched at a pulling rate of 50 mm/min and the values of stress (MPa) and strain (mm) were measured until the specimen was broken.

The results are summarized below in Table 4:

TABLE 4

| | Time | | | Tensile | Percentage |
|---|---|---|---|---|---|
| | allowed to | | Strain | Strength | of Self- |
| Mixture | self-heal | | (%) | (MPa) | healing |
| PPC1 + GB | Before cutting | | 1,000 | 1.40 | |
| | 5 | min. | 177 | 0.80 | 57 |
| | 30 | min. | 298 | 0.90 | 64 |
| | 8 | h. | 294 | 0.91 | 65 |
| PPC1 + DEP | Before cutting | | 1,000 | 0.69 | |
| | 5 | min. | 175 | 0.40 | 58 |
| | 30 | min. | 202 | 0.47 | 68 |
| | 8 | h. | 363 | 0.65 | 94 |
| PPC1 + BEA | Before cutting | | 1,000 | 0.57 | — |
| | 5 | min. | 262 | 0.39 | 68 |
| | 30 | min | 201 | 0.44 | 77 |
| | 8 | h | 353 | 0.51 | 90 |
| PPC1 + PGA | Before cutting | | 417 | 1.00 | — |
| | 5 | min. | 51 | 0.39 | 39 |
| | 30 | min | 77 | 0.41 | 41 |
| | 8 | h | 127 | 0.66 | 66 |
| PPC1 + TEP | Before cutting | | 417 | 0.49 | — |
| | 5 | min. | 51 | 0.36 | 73 |
| | 30 | min | 205 | 0.45 | 92 |
| | 8 | h | 221 | 0.48 | 98 |

It can be seen from Table 4 that the self-healing behaviour could be observed very early in the tests, and that longer periods of time lead to a more complete recovery. All mixtures tested showed a recovery in tensile strength above 60% after only 8 hours.

In many cases, eye inspection could not identify samples that had been cut, a remarkable result.

Thus, the mixtures of the disclosure preferably recover up to 10%, preferably up to 20%, more preferably up to 30%, more preferably up to 40%, more preferably up to 50%, more preferably up to 60%, of their tensile strength after 8 hours at a temperature between 15° C. and 60° C., preferably at room temperature, by arranging the cut ends in physical contact. The percentage was calculated by dividing the tensile strength of the sample after 8 hours by the tensile strength of the same sample before cutting, and multiplying the result by 100. Preferably, the testing conditions are the following: after being cut in half at the middle and the two halves being arranged to be in physical contact within five minutes of cutting for 8 hours at the temperature specified, preferably 25° C., without a sequestered healing agent, the material being cut and measured according to the ISO 37 standard by using type 2 dumbbell specimens.

It is not only remarkable the recovery after 8 hours, but also that very high recovery percentages of the tensile strength after only 5 minutes, as high as 68% in the case of mixture PPC1+BEA.

1. A use as a self-healing material of a mixture comprising a poly(alkylene carbonate) and a non-polymeric organic molecule having a molecular weight below 1,000 Da.

2. The use according to claim 1, wherein said poly(alkylene carbonate) is poly(propylene carbonate).

3. The use according to claim 1, wherein said non-polymeric organic molecule has a Hansen parameter of 5 MPa^{0.5} or more.

4. The use according to claim 1, wherein said non-polymeric organic molecule has a Hansen parameter comprised between 5 and 25 MPa^{0.5}.

5. The use according to claim 1, wherein said non-polymeric organic molecule has a molar volume of less than 700 cm³/mol.

6. The use according to claim 5, wherein said non-polymeric organic molecule has a molar volume of less than 600 cm³/mol.

7. The use according to claim 1, wherein said non-polymeric organic molecule has a molar volume of comprised between 5 cm³/mol and 600 cm³/mol.

8. The use according to claim 1, wherein said non-polymeric organic molecule has a molar volume of less than 700 cm³/mol and a Hansen parameter of 5 MPa^{0.5} or more.

9. The use according to claim 1, wherein said non-polymeric organic molecule has a molar volume comprised between 5 cm³/mol and 600 cm³/mol and a Hansen parameter comprised between 5 MPa^{0.5} and 25 MPa^{0.5}.

10. The USE according to claim 1, wherein the mixture comprises between 0.1 wt % and 19 wt %, with respect to the total weight of the mixture, of the non-polymeric organic molecule.

11. The use according to claim 1, wherein said mixture comprises between 2 wt % and 19 wt %, with respect to the total weight of the mixture, of the non-polymeric organic molecule, and between 81 wt % and 98 wt %, with respect to the total weight of the mixture, of the poly(alkylene carbonate).

12. The use according to claim 1, wherein said mixture comprises between 5 wt % and 15 wt %, with respect to the total weight of the mixture, of the non-polymeric organic molecule, and between 85 wt % and 95 wt %, with respect to the total weight of the mixture, of the poly(alkylene carbonate).

13. The use according to claim 1, wherein the mixture comprises less than 5 wt % of a polyether carbonate polyol having CO₂ groups randomly incorporated in the chemical structure thereof, wherein the content of CO₂ ranges from 0.5 to 40 wt %, based on the total weight of the polyether carbonate polyol.

14. The use according claim 1, wherein the mixture comprises no polyether carbonate polyol having CO₂ groups randomly incorporated in the chemical structure thereof, wherein the content of CO₂ ranges from 0.5 to 40 wt %, based on the total weight of the polyether carbonate polyol.

15. The use according to claim 1, wherein the mixture comprises no tackifying agents.

16. The use according to claim 1, wherein the non-polymeric organic molecule is a compound of formula (I) 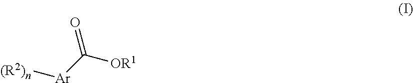
wherein
Ar represents a C₆-C₂₄ aryl residue;
R¹ is selected from the group consisting of a C₁-C₂₄ alkyl, C₂-C₂₄ alkenyl, C₂-C₂₄ alkynyl, C₁-C₂₄ alcoxyl, C₂-C₂₄ alcoxylalkyl, C₆-C₁₅ aryl, C₇-C₁₅ arylalkyl, optionally substituted with 1, 2, 3 or 4 groups independently selected from those of formula —O—(O═C)—(C₆-C₁₅ Aryl), preferably benzoate;
R² is selected from the group consisting of a C₁-C₂₄ alkyl, C₂-C₂₄ alkenyl, C₂-C₂₄ alkynyl, C₁-C₂₄ alcoxyl, C₂-C₂₄ alcoxylalkyl, C₆-C₁₅ aryl, C₇-C₁₅ arylalkyl, —OH, —(C═O)—OR¹ and —OR¹, wherein R¹ can be as defined above; and
n is number selected from 0, 1, 2, 3, 4 or 5.

17. The use according to claim 1, wherein the non-polymeric organic molecule is a compound of formula (V) 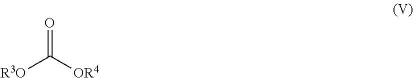
wherein R³ and R⁴ are each selected from the group consisting of C₁-C₂₄ alkyl and C₂-C₂₄ alkenyl; or which, together with the carbonate moiety, form a 5, 6 or 7 membered ring.

18. The use according to claim 1, wherein the non-polymeric organic molecule is a compound of formula (VI) 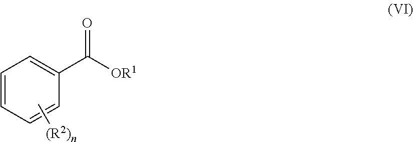
wherein R⁹, R¹⁰ and R¹¹ are each selected from the group consisting of C₁-C₂₄ alkyl, C₂-C₂₄ alkenyl, C₂-C₂₄ alkynyl, C₁-C₂₄ alcoxyl, C₂-C₂₄ alcoxylalkyl, C₆-C₁₅ aryl and C₇-C₁₅ arylalkyl.

19. The use according to claim 1, wherein the non-polymeric organic molecule is a compound of formula (VII) 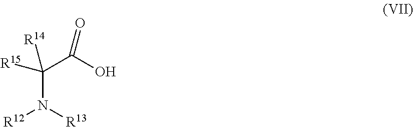
wherein R¹² and R¹³ are each selected from the group consisting of hydrogen, C₁-C₁₂, alkyl, C₂-C₁₂ alkenyl and —O—(C═O)—(C₁-C₁₂ alkyl); and
R¹⁴ and R¹⁵ are each selected from the group consisting of hydrogen, C₁-C₁₂, alkyl and C₂-C₁₂ alkenyl, each optionally substituted by a residue selected from the group consisting of —OR¹⁶, —N(R¹⁷)(R¹⁸), and —SR¹⁶, wherein each of R¹⁶, R¹⁷ and R¹⁸ is independently selected from hydrogen, C₁-C₆ alkyl, C₂-C₆ alkenyl and C₂-C₆ alkynyl, preferably selected from hydrogen and C₁-C₆ alkyl.

20. The use according to claim 1 in the preparation of a package, a leak-tight article, a film, a sealant, an adhesive, or a coating.

21. The use of a non-polymeric organic molecule having a molecular weight below 1,000 Da to impart self-healing behavior to a mixture comprising a poly(alkylene carbonate).

22. A method for healing a damaged mixture comprising poly(alkylene carbonate) and a non-polymeric organic molecule having a molecular weight below 1,000 Da, including the step of arranging the damaged parts of the mixture to be in physical contact with each other.
